(19) United States
(12) Patent Application Publication
(10) Pub. No.: US 2026/0056931 A1
(43) Pub. Date: Feb. 26, 2026

(54) IDENTIFYING AND CATEGORIZING SPARSE DATA STREAMS FOR BITMASK COMPRESSION

(71) Applicant: BANK OF AMERICA CORPORATION, Charlotte, NC (US)

(72) Inventors: Madhumitha Swaminathan Rangarajan, Chennai, Tamilnadu (IN); Architha Ellenki, Plano, TX (US); Swathi Karthikeyan, Arakkonam, Tamilnadu (IN); Dhuvaraga Prasath B., Tiruppur, Tamilnadu (IN)

(73) Assignee: BANK OF AMERICA CORPORATION, Charlotte, NC (US)

(21) Appl. No.: 18/809,835

(22) Filed: Aug. 20, 2024

(51) Int. Cl. G06F 16/23

(52) U.S. Cl. CPC G06F 16/2365

(57) ABSTRACT

Bitmask compression of data based on data sparsity patterns. A dataset that received as an input. The dataset includes nodes with each node including data. Each node is analyzed for sparsity and one of a plurality of sparsity patterns is determined of each node. Based on the determined sparsity pattern, a bitmask compression process is identified for each node; and, in response to identifying the bitmask compression process, bits are generated and allocated as part of the bitmask compression process to each node in the dataset to compress the dataset.

### TECHNOLOGICAL FIELD

The present invention is related generally to bitmask compression based on data sparsity patterns and, more specifically, compressing data through implementation of Artificial Intelligence (AI) and Machine Learning (ML) to identify sparsity patterns of data and generate and allocate bits based on the sparsity pattern.

### BACKGROUND

Organizations and entities are accumulating vast amounts of existing data and are faced with a continuous influx of data as well. With such an increase in the volume of data comes an increase in the costs required to store the data. Additionally, the volume of data can also elongate data transfer times. As such, the effective compression of data is necessary to properly handle the vast amounts of data being stored and transferred by organizations and entities on a day-to-day basis. Effective and efficient data compression would decrease storage costs as well as data transfer times while also preserving privacy and ensuring accuracy.

Applicant has identified a number of deficiencies and problems associated with existing data compression systems and methods. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for systems, methods, computer program products and the like that provide for data compression based on data sparsity patterns. Specifically, an AI engine is used to identify sparsity patterns in data and compress the data in the most efficient manner for that sparsity pattern.

The AI engine receives as input a dataset. The dataset may come in the form of a data storage system, one or more databases, and the like. The dataset may comprise a number of nodes, where each node may contain a portion of the dataset. Nodes may also be empty or have null or zero values stored within them. The AI engine analyzes each node in the dataset for data sparsity and based on the data sparsity, identifies a sparsity pattern for each node. Data sparsity is when some percentage of data within a set of data is missing or is set to zero. For example, in a database table, empty cells may indicate data sparsity. Based on the identified sparsity pattern for each node, the AI engine will then determine a bitmask compression process for that node. Bit-masking comprises encoding data as a series of bits, where each bit is represented by a binary digit or Boolean value of 1 or 0. Bitmask compression comprises using the bit-masking process to compress large amounts of data, as bits are the smallest unit of data. In determining the bitmask compression process for any given node, the AI engine essentially determines how many bits would be required for the data in the node, the most effective way to encode the data, and the like. The AI engine then generates and allocates bits to the data in each node in the dataset. As such the entire dataset may be compressed using the bit-masking process by the AI engine based on the sparsity pattern of each node.

Examples of different types of sparsity patterns include, but are not limited to, temporal sparsity, periodic sparsity, bursty sparsity, clustered sparsity, global sparsity, gradual sparsity and the like. Temporal sparsity may comprise a sparsity pattern where the data is not uniformly distributed between successive data points, or where data points are sparse across different time periods. Periodic sparsity may comprise a sparsity pattern where the data, measured over time, is abundant during certain periods and is sparse (or is lacking) during others. Such sparsity may follow a regular pattern. Bursty sparsity may comprise a sparsity pattern where the data is irregular and does not follow a defined pattern but occurs in bursts during specific periods. Clustered sparsity may comprise a sparsity pattern where the data tends to form clusters based on specific contexts, such as geographic regions. Global sparsity may comprise a sparsity pattern where the data is sparse across the entire dataset without any specific pattern or clustering. Finally, gradual sparsity may comprise a sparsity pattern where the data, measured over time, starts off in abundance and gradually decreases, becoming sparser over time.

In specific embodiments of the invention, the AI engine may also analyze, determine the sparsity patterns of, and generate and allocate bits for multiple nodes, or all nodes of the dataset, simultaneously (i.e., in parallel). As such, the data compression would be even more efficient and take less time.

In further embodiments of the invention, the AI engine may also encrypt the data in each node during the bitmask compression process. Such data may be decrypted when the data is decompressed.

The AI engine may also analyze the metadata of each node before the data in the node is compressed and after the data is decompressed. Comparing the metadata of the node before and after compression could allow the AI engine to ensure that no data was lost or missing during the bitmask compression process. For example, if the size of the data in a node decreases after the data is decompressed, that would indicate that some data may have been lost during the compression process or during decompression. In further embodiments, the AI engine may be able to retrieve the missing data or alert the user of the system that data may be missing.

In some embodiments of the invention the AI engine may be configured to adapt the bitmask compression process for nodes that do not align with known sparsity types. For example, if the data in a node does not conform to one of the known sparsity patterns, such as the sparsity patterns described above, the AI engine may still apply a bitmask compression process to compress the data. The engine may do so, for example, by finding the closest sparsity pattern that could fit, or may find a combination of sparsity patterns that could fit and determine the bitmask compression process accordingly.

In further embodiments, the AI engine may use historical data to determine sparsity patterns and bitmask compression processes. Historical data may comprise previous determinations of sparsity patterns and bitmask compression processes from previous dataset inputs. For example, the AI engine may essentially “learn” each time it makes any determinations for a dataset input and use what it learned for the next time it has to make a determination for a subsequent dataset input. As another example, the AI engine may “learn” in smaller increments, with each determination at the node-level, and use what it learned for the subsequent nodes in the same dataset.

A computer-implemented method for bitmask compression based on data sparsity patterns defines second embodiments of the invention. The computer-implemented method may be executed by one or more computing processor devices. The method includes receiving a dataset as input, where the dataset comprises a number or nodes, and each node contains some data. One or more nodes may also contain no data or contain null or zero values. The method further includes analyzing each node of the dataset for sparsity and determining the sparsity pattern of each node. Sparsity patterns may include, but are not limited to, temporal sparsity, periodic sparsity, bursty sparsity, clustered sparsity, global sparsity, gradual sparsity and the like. The absence of sparsity may also be a sparsity pattern. The method further includes determining a bitmask compression process for each node based on the determined sparsity pattern of that node. After determining the bitmask compression process for a node, the method further includes generating and allocating bits to the data in each node to compress the data. Each bit is represented by a binary digit or Boolean value of 1 or 0.

As previously discussed, examples of different types of sparsity patterns include, but are not limited to, temporal sparsity, periodic sparsity, bursty sparsity, clustered sparsity, global sparsity, gradual sparsity and the like.

In specific embodiments of the invention, the method further comprises analyzing, determining the sparsity pattern of, and generating and allocating bits for multiple nodes in the dataset simultaneously. The method may also include compressing data in all nodes of the dataset simultaneously.

In further embodiments, the method may comprise encrypting the data in each node during the bitmask compression process. The encrypted data may be decrypted when the data is decompressed.

In other specific embodiments, the method may further comprise analyzing the metadata of each node before the data in the node is compressed and after the data is decompressed. Comparing the metadata of the node before and after compression could ensure that no data was lost or missing during the bitmask compression process. For example, if the size of the data in a node decreases after the data is decompressed, that would indicate that some data may have been lost during the compression process or during decompression. In further embodiments, the method may further comprise retrieving the missing data or alerting the user of the system that data may be missing.

In some embodiments of the invention method may further comprise adapting the bitmask compression process for nodes that do not align with known sparsity types. For example, if the data in a node does not conform to one of the known sparsity patterns, such as the sparsity patterns described above, the method may still apply a bitmask compression process to compress the data. The method may also, for example, include finding the closest sparsity pattern that could fit, or finding a combination of sparsity patterns that could fit and determining the bitmask compression process accordingly.

In further embodiments, the method may include using historical data to determine sparsity patterns and bitmask compression processes. Historical data may comprise previous determinations of sparsity patterns and bitmask compression processes from previous dataset inputs.

A computer program product including a non-transitory computer-readable medium defines third embodiments of the invention. The computer-readable medium includes sets of code for cause computing device(s) to receive a dataset with a number of nodes containing data, analyze each node for sparsity, and determine the sparsity pattern of the data in each node. In some embodiments, one or more nodes in the dataset may be empty or contain zero or null values. In specific embodiments of the invention the sparsity patterns include temporal sparsity, periodic sparsity, bursty sparsity, clustered sparsity, global sparsity, and gradual sparsity. In further specific embodiments, the absence of sparsity may also be a sparsity pattern. In yet other embodiments, there may be other identifiable sparsity patterns. The sets of codes further cause the computing device(s) to determine a bitmask compression process for each node based on the sparsity pattern determined for that node and generate and allocate bits to the data in each node to compress such data. Bits are the smallest unit that can be stored and are represented by binary digits or Boolean values, 1 and 0. The sets of codes cause the computing device(s) to compress the data in the nodes by encoding the data in a series of bits as determined by the bitmask compression process determined based on the sparsity patterns of the data.

As previously noted, examples of different types of sparsity patterns include, but are not limited to, temporal sparsity, periodic sparsity, bursty sparsity, clustered sparsity, global sparsity, gradual sparsity and the like.

In specific embodiments of the invention, the sets of codes may further cause the computing device(s) to analyze, determine the sparsity pattern of, and generate and allocate bits for multiple nodes in the dataset, or all nodes in the dataset, simultaneously.

In further embodiments, the set of codes may further cause the computing device(s) to encrypt the data in each node during the bitmask compression process. The encrypted data may be decrypted when the data is decompressed.

In other specific embodiments, the set of codes may further cause the computing device(s) to analyze the metadata of each node before the data in the node is compressed and after the data is decompressed. Comparing the metadata of the node before and after compression could ensure that no data was lost or missing during the bitmask compression process. For example, if the size of the data in a node decreases after the data is decompressed, that would indicate that some data may have been lost during the compression process or during decompression. In further embodiments, the set of codes may further cause the computing device(s) to retrieve the missing data or alert the user of the system that data may be missing.

In some embodiments of the invention, the set of codes may further cause the computing device(s) to adapt the bitmask compression process for nodes that do not align with known sparsity types. For example, if the data in a node does not conform to one of the known sparsity patterns, such as the sparsity patterns described above, the set of codes may still cause the computing device(s) to apply a bitmask compression process to compress the data. The bitmask compression process may be determined then by finding the closest sparsity pattern that could fit, or finding a combination of sparsity patterns that could fit.

In further embodiments, the set of codes may further cause the computing device(s) to use historical data to determine sparsity patterns and bitmask compression processes. Historical data may comprise previous determinations of sparsity patterns and bitmask compression processes from previous dataset inputs.

Thus, according to embodiments of the invention, which will be discussed in greater detail below, the present invention provides for the compression of data using bit-masking based on identified data sparsity patterns. Specifically, an AI engine receives a dataset with a number of nodes as input, analyzes each of the nodes for sparsity, determines a sparsity pattern for each node, determines a bitmask compression process for each node based on the sparsity pattern, and generates and allocates bits to compress the data in each node based on the bitmask compression process. In specific embodiments of the invention, sparsity patterns may include temporal sparsity, periodic sparsity, bursty sparsity, clustered sparsity, global sparsity, gradual sparsity, or an absence of sparsity. In some embodiments, the AI engine can analyze multiple, or all, nodes of a dataset, and generate and allocate bits to those nodes, based on each node's sparsity pattern, and determined bitmask compression process, simultaneously. In further embodiments of the invention, the AI engine may encrypt the data during the bitmask compression process and may compare metadata before and after compression to ensure no data is lost or missing. In yet other embodiments, the AI engine may adapt the bitmask compression process for nodes that do not align with known sparsity patterns and may use historical data to determine sparsity patterns and bitmask compression processes.

The features, functions, and advantages that have been discussed may be achieved independently in various embodiments of the present invention or may be combined with yet other embodiments, further details of which can be seen with reference to the following descriptions and drawings.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for bitmask compression based on data sparsity patterns, in accordance with an embodiment of the disclosure;

FIG. 2 illustrates a process flow for bitmask compression based on data sparsity patterns, in accordance with an embodiment of the disclosure.

FIG. 3 illustrates an exemplary architecture of a machine learning (ML) subsystem, in accordance with an embodiment of the disclosure.

FIG. 4 illustrates a process flow for bitmask compression based on data sparsity patterns, in accordance with an embodiment of the disclosure.

FIG. 5 illustrates a process flow for bitmask compression based on data sparsity patterns, more specifically related to parallel processing, encryption and metadata exchange, in accordance with an embodiment of the disclosure.

FIG. 6 illustrates a process flow for bitmask compression based on data sparsity patterns, more specifically related to the data compression process, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users.

Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary”is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present invention uses a bit-masking process, where bits represented by binary digits or Boolean values 1 or 0 are allocated to data, to compress data based on the data's sparsity patterns.

With expanding business operations, and the need for extensive datasets for emerging technologies like generative AI, organizations and entities are facing a continuous and large influx of data in addition to accumulating vast amounts of existing data. This results in increased costs (for storage or transfer, for example) and a decrease in efficiency when it comes to handling the data or transferring it.

Data compression becomes crucial for storing, handling, or transferring vast amounts of data. To effectively compress data, sparsity in the data should be taken into account. Data sparsity refers to a lack of data, or missing data. For example, empty cells in a spreadsheet would indicate data sparsity. Essentially, by properly dealing with empty space in a dataset, data compression may be done more efficiently and effectively. On the other hand, improperly handling data sparsity could result in the improper decompression of data or in missing or lost data. For example, if a spreadsheet with empty cells is compressed by essentially getting rid of the empty space and filling the empty cells with existing data, the results of the spreadsheet may be skewed when decompressed (data in just one column may move up a row, for example). The present invention thus identifies the existence of sparsity for different chunks (i.e., nodes) of a dataset and determines a sparsity pattern for each chunk. The present invention then compresses the data using a bit-masking process based on the sparsity pattern it determined for each chuck of data in the dataset. Bit-masking includes encoding data in a series of bits to compress the data, as bits are the smallest units that can be stored. By using bits, the invention can properly encode sparse data such that it would not skew the data upon decompression. In this manner, the present invention can efficiently and effectively compress data.

Accordingly, the present disclosure includes an AI engine that receives a dataset with a number of nodes as input, analyzes each of the nodes for sparsity, determines a sparsity pattern for each node, determines a bitmask compression process for each node based on the sparsity pattern, and generates and allocates bits to compress the data in each node based on the bitmask compression process. In specific embodiments of the invention, sparsity patterns may include, but are not limited to, temporal sparsity, periodic sparsity, bursty sparsity, clustered sparsity, global sparsity, gradual sparsity, or an absence of sparsity. Temporal sparsity may comprise a sparsity pattern where the data is not uniformly distributed between successive data points, or where data points are sparse across different time periods. Periodic sparsity may comprise a sparsity pattern where the data, measured over time, is abundant during certain periods and is sparse (or is lacking) during others. Such sparsity may follow a regular pattern. Bursty sparsity may comprise a sparsity pattern where the data is irregular and does not follow a defined pattern but occurs in bursts during specific periods. Clustered sparsity may comprise a sparsity pattern where the data tends to form clusters based on specific contexts, such as geographic regions. Global sparsity may comprise a sparsity pattern where the data is sparse across the entire dataset without any specific pattern or clustering. Finally, gradual sparsity may comprise a sparsity pattern where the data, measured over time, starts off in abundance and gradually decreases, becoming sparser over time. In some embodiments, the AI engine can analyze multiple, or all, nodes of a dataset, and generate and allocate bits to those nodes, based on each node's sparsity pattern, and determined bitmask compression process, simultaneously. In further embodiments of the invention, the AI engine may encrypt the data during the bitmask compression process and may compare metadata before and after compression to ensure no data is lost or missing. In yet other embodiments, the AI engine may adapt the bitmask compression process for nodes that do not align with known sparsity patterns and may use historical data to determine sparsity patterns and bitmask compression processes.

What is more, the present disclosure provides a technical solution to a technical problem. As described herein, the technical problem includes compressing data without taking into account data sparsity such that the decompressed data may yield skewed results. The technical solution presented herein allows for using bit-masking based on identified sparsity patterns to compress data. In particular, bitmask compression based on data sparsity patterns is an improvement over existing solutions to data compression that do not take into account data sparsity, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

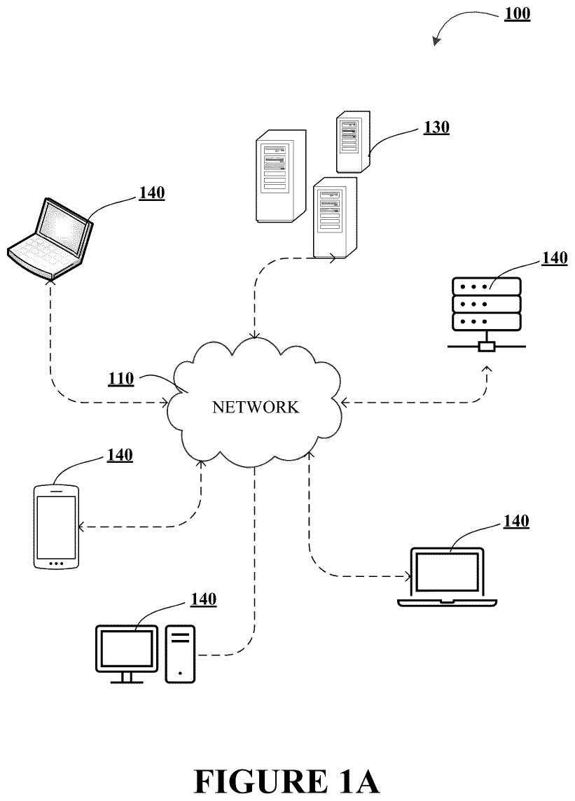

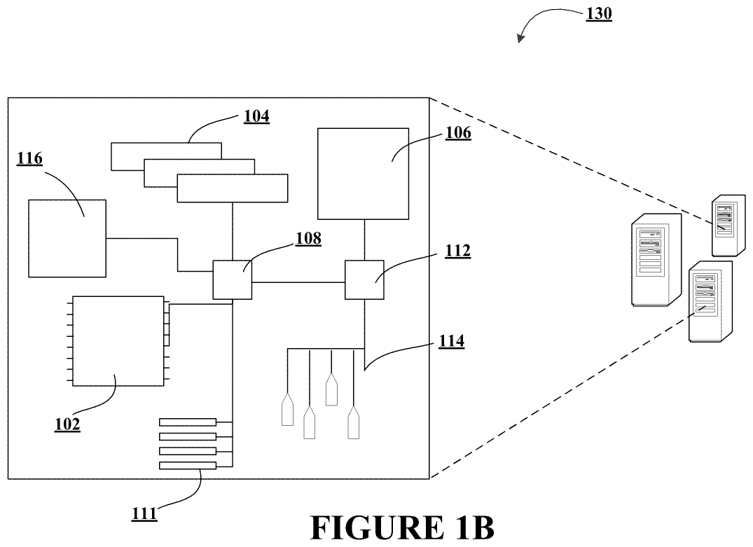

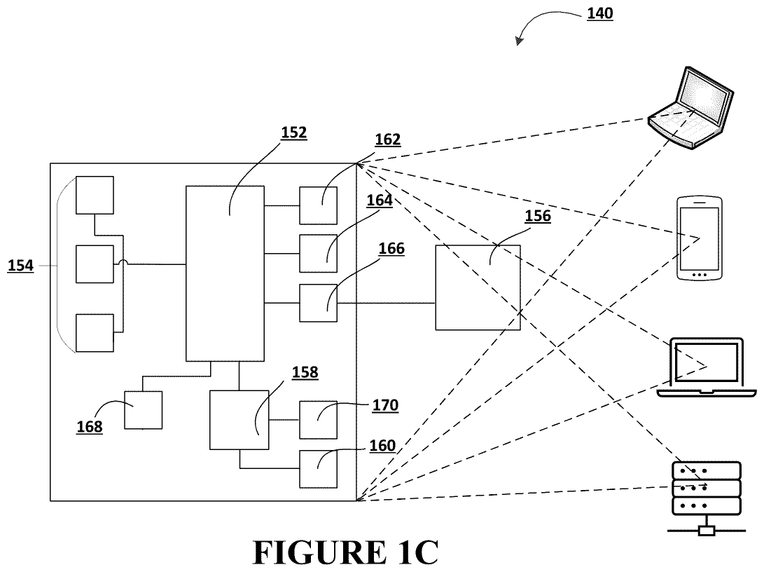

FIGS. 1A-1C illustrate technical components of an exemplary distributed computing environment for bitmask compression based on data sparsity patterns 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, or the like) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

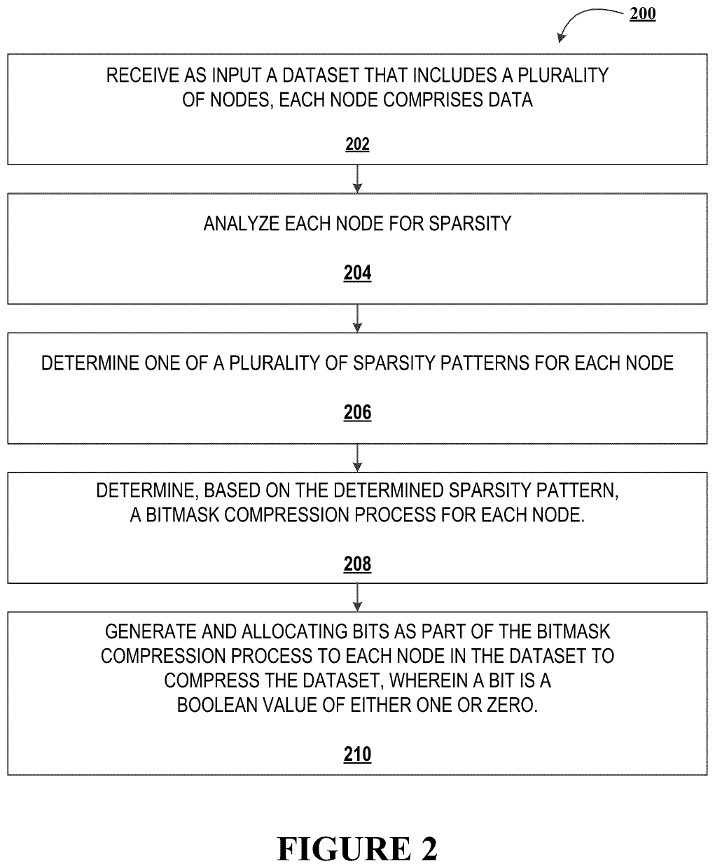

FIG. 2 depicts a flow diagram of method 200 for bitmask compression based on data sparsity patterns. At Event 202, a dataset is received as input. The dataset includes multiple nodes. Each node includes data. In some embodiments, data may include null or zero values and as such, a node may essentially be empty. In some embodiments, a dataset may include only one node.

At Event 204, each node in the dataset is analyzed for sparsity. In specific embodiments, analyzing each node includes identifying whether or not a node contains data, and whether there is any sparsity in the data. In further embodiments, analyzing each node further includes inspecting the data for any patterns in sparsity. In some embodiments, the method may include analyzing multiple, or all, nodes simultaneously.

At Event 206, A sparsity pattern is determined for each node. In specific embodiments, determining a sparsity pattern includes categorizing the data into a known sparsity pattern based on the recognized pattern in the sparsity of the data. Known sparsity patterns include, but are not limited to, temporal sparsity, periodic sparsity, bursty sparsity, clustered sparsity, global sparsity, gradual sparsity and the like. The absence of sparsity may also be considered as a known sparsity pattern. In other embodiments, the sparsity of the data may not align with a known sparsity pattern. In some embodiments, the method may include determining sparsity patterns for multiple, or all, nodes simultaneously. In some embodiments, the method may further include using historical data to categorize the data based on the sparsity pattern. Historical data may include previous determinations of sparsity patterns. Essentially, how data from previous datasets was categorized based on the known sparsity patterns may factor into the determination of a sparsity pattern for the data at hand.

At Event 208, a bitmask compression process is determined for each node based on the sparsity pattern determined for that node. In specific embodiments, determining a bitmask compression process may include identifying how many bits are required to encode the data, which may be done based on the size or other characteristics of the data. In some embodiments, the method may further include determining a bitmask compression process for multiple, or all, nodes simultaneously. In other embodiments, where the sparsity of the data does not align with a known sparsity pattern, the method may further include adapting the determination of a bitmask compression process such that it does not rely on the categorization of the sparsity of the data into a known sparsity pattern.

At Event 210, bits are generated and allocated to the data in each node to compress the dataset 210. A bit is the smallest unit of data that is represented by a binary digit or Boolean value of 1 or 0. The data in each node is encoded with a series of bits, thus reducing the size of the data, i.e., compressing the data. In some embodiments, the method may further include compressing data in multiple, or all, nodes simultaneously. In further embodiments, the method may include analyzing, determining sparsity patterns and bitmask compression processes, and compressing data for each node, multiple nodes, or all nodes simultaneously. In other embodiments, the method may also include encrypting data in each node. In yet other embodiments, the method may also include comparing the metadata of each node before compression with the metadata of each node after compression to ensure that no data was lost during the compression process.

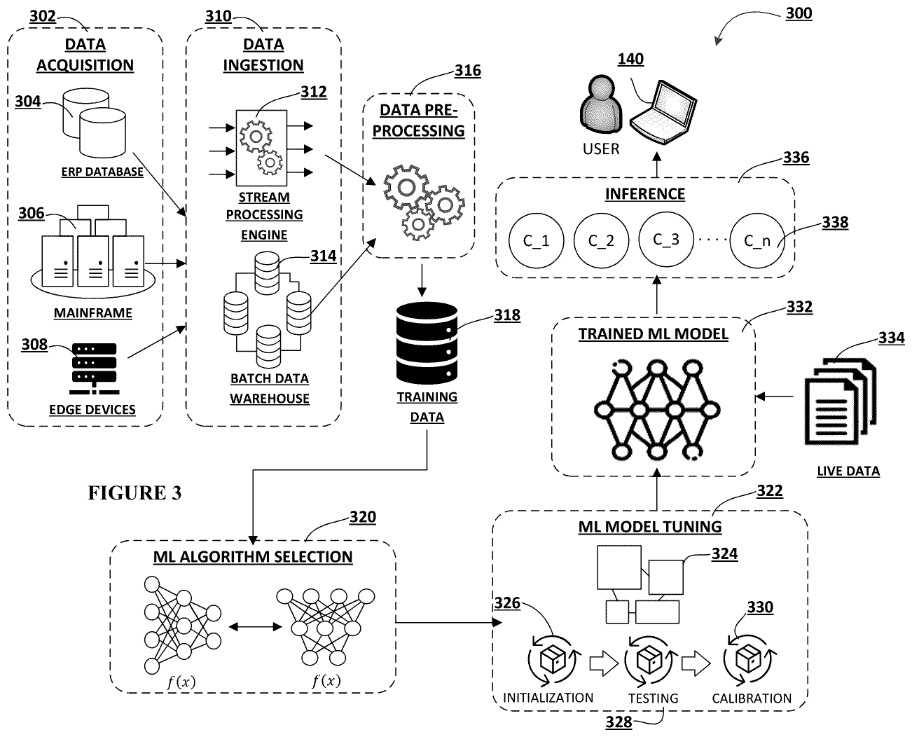

FIG. 3 illustrates an exemplary machine learning (ML) subsystem architecture 300, in accordance with an embodiment of the invention. The machine learning subsystem 300 may include a data acquisition engine 302, data ingestion engine 310, data pre-processing engine 316, ML model tuning engine 322, and inference engine 336.

The data acquisition engine 302 may identify various internal and/or external data sources to generate, test, and/or integrate new features for training the machine learning model 324. These internal and/or external data sources 304, 306, and 308 may be initial locations where the data originates or where physical information is first digitized. The data acquisition engine 302 may identify the location of the data and describe connection characteristics for access and retrieval of data. In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices) , i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 322 may be used to train a machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering) , semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like) , an instance-based method (e.g., k-nearest neighbor, learning vector quantization, self-organizing map, or the like) , a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the ML model tuning engine 322 may dynamically vary hyperparameters each iteration (e.g., number of trees in a tree-based algorithm or the value of alpha in a linear algorithm) , run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2... C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2... C_n 338) live data 334 based on how similar they are to one another to solve exploratory challenges where little is known about the data, provide a description or label (e.g., C_1, C_2... C_n 338) to live data 334, such as in classification, and/or the like. These categorized outputs, groups (clusters), or labels are then presented to the user input system 130. In still other cases, machine learning models that perform regression techniques may use live data 334 to predict or forecast continuous outcomes.

It will be understood that the embodiment of the machine learning subsystem 300 illustrated in FIG. 3 is exemplary and that other embodiments may vary. As another example, in some embodiments, the machine learning subsystem 300 may include more, fewer, or different components.

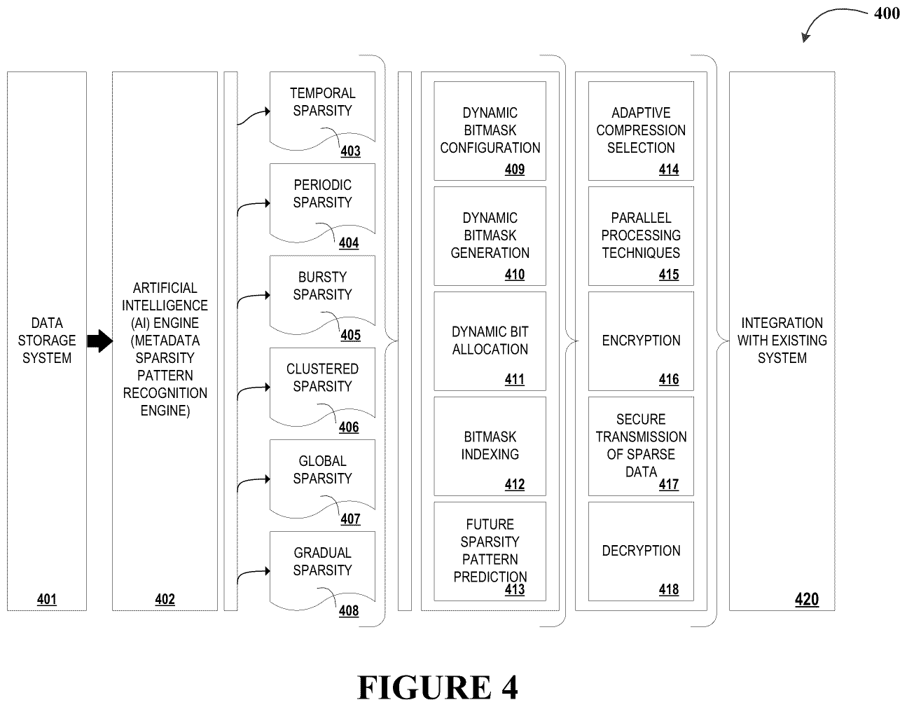

FIG. 4 depicts a process flow 400 for bitmask compression based on sparsity patterns for one embodiment of the invention. The AI engine 402 receives a data storage system 401 as input. The data storage system may comprise multiple nodes of data. In one embodiment of the invention, the AI engine analyzes the data in each node of the data storage system and categorizes the nodes into the following categories of known sparsity patterns based on the pattern of data sparsity it identifies in the node: temporal sparsity, periodic sparsity, bursty sparsity, clustered sparsity, global sparsity, and gradual sparsity. In other embodiments, the absence of sparsity may also be a known sparsity pattern.

Temporal sparsity 403 is a sparsity pattern where the data is not uniformly distributed between successive data points, or where data points are sparse across different time periods. For example, in the context of customer transaction data at financial institution, annual loan payments may indicate temporal sparsity, as they occur infrequently, as opposed to daily withdrawals. Periodic sparsity 404 is a sparsity pattern where the data, measured over time, is abundant during certain periods and is sparse (or is lacking) during others. Such sparsity may follow a regular pattern. For example, if a dataset being considered included the number of customer transactions made by each customer at a financial institution, periodic sparsity may represent monthly salary deposits, where such transactions happen regularly once a month, but are sparse when considering daily transactions within a month.

Bursty sparsity 405 is a sparsity pattern where the data is irregular and does not follow a defined pattern but occurs in bursts during specific periods. Using the customer transaction data described above as an example, bursty sparsity may represent sudden spikes in credit card transactions during holiday shopping seasons. Clustered sparsity 406 is a sparsity pattern where the data tends to form clusters based on specific contexts, such as geographic regions. Following the previous example, clustered sparsity may represent high transaction volumes in large city branches of a financial institution as compared to sparse transactions in rural branches. As another example, clustered sparsity may also represent a number of overall transactions in person at the financial institution over weekdays but no transactions in person over the weekend when the financial institution is closed. Global sparsity 407 is a sparsity pattern where the data is sparse across the entire dataset without any specific pattern or clustering. For example, high value transactions may be rare across the entire customer base and timeline. Finally, as shown in FIG. 4, gradual sparsity 408 may comprise a sparsity pattern where the data, measured over time, starts off in abundance and gradually decreases, becoming sparser over time. An example would be a decline in the number of transactions from a customer who is gradually reducing their interaction with the bank.

In specific embodiments of the invention, the AI engine 402 determines a bitmask compression process for each node based on the sparsity pattern of that node. Determining a bitmask compression process includes dynamic bitmask configuration 409, which means identifying the bitmask requirements of the node, including, for example, how many bits would be needed to encode the data in the node, based on the size and other characteristics of the node. In some embodiments, bitmask configuration may further include collecting and analyzing the metadata of the node to determine the bitmask requirements. Based on the bitmask compression process identified, the AI engine performs (i) dynamic bitmask generation 410 to generate bits, or a series of bits, and (ii) dynamic bit allocation 411 to allocate the generated bits to the data in the node. The combination of the bitmask generation and bitmask allocation is collectively referred to as the bitmask compression process. In specific embodiments of the invention, when system finds consecutive null values, for multiple days, for example, instead of allocating a bit for each value, the system will instead allocate only one bit and keep a count of the number of days for which the value is null. This allows for the efficient handling of null values in bit allocation.

In some embodiments of the invention, the AI engine 402 may be configured for bitmask indexing 412. Bitmask indexing may comprise creating and managing indexes based on the bitmasks created and used for the compressed data to improve data retrieval efficiency. For example, bitmask indexing can be used to quickly access all transactions flagged as fallacious from a large dataset associated with a financial institution. In some specific embodiments of the invention, bitmask indexing may comprise a process analogous to marking the data in a node, after the data has been compressed such that the bitmask for that data would be marked, with key characteristics about the data. In this way, all data associated with those key characteristics can be retrieved without decompressing the data. In some embodiments, the decompression of the data can accompany the retrieval of the data based on the indexing.

The AI engine 402 may be further configured to perform future sparsity pattern prediction 413 in which historical data is used to predict future or otherwise identify sparsity patterns 413. Every time the AI engine analyzes data for sparsity and identifies sparsity patterns for that data, it essentially learns from determination and uses that knowledge to make future determinations.

The AI engine 402 may be further configured to perform adaptive compression selection 414, in which sparsity patterns are adapted for data that does not align with the known sparsity patterns it was trained on. In specific embodiments, the AI engine may adapt by creating a new sparsity pattern, or finding a combination of the known sparsity patterns that would align with the sparsity pattern in the data. In other embodiments, the AI engine may adapt by determining that a known sparsity pattern could be expanded in a minor way such that the sparsity pattern of the data would align. Such a determination may impact future determinations of sparsity patterns. In further embodiments, the AI engine could further refine 413 the scope of the known sparsity patterns with each determination.

The AI engine 402 may further be configured to use parallel processing techniques 415 to process multiple or all nodes of a dataset simultaneously, where processing a node may include analyzing the node for sparsity, determining a sparsity pattern for the node, determining a bitmask compression process, and generating and allocating bits to compress the data in the node. Parallel processing can be done by using multiple processors to process the data, which would increase the computation speed as well.

The AI engine may further be configured to perform encryption 416 on the data in a node during the bitmask compression process. Encryption provides secure transmission 417 of the data with minimal data loss due to the bitmask compression and maintaining confidentiality due to the encryption. The receiving system can then perform decryption 418 on the data. Once the data has undergone data compression, integration of the data with existing systems 410 can be undertaken.

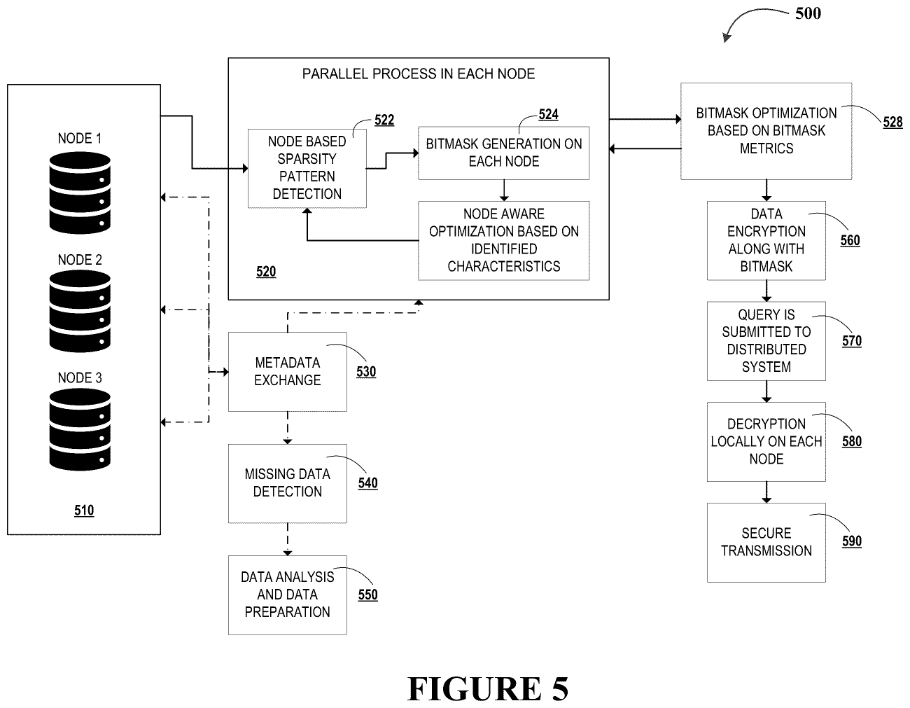

FIG. 5 depicts a process flow 500 for bitmask compression based on sparsity patterns for specific features of a specific embodiment of the invention. The dataset 510 includes a number of nodes (e.g., Node 1, Node 2, Node 3). The nodes are all processed in parallel as depicted in block 520. In processing each node, the system performs node-based sparsity pattern detection 522 to identify/detect the sparsity pattern of each node and bitmask generation 524 to generate a bitmask for each node by creating and allocating bits for the data in each node. In specific embodiments, the characteristics of each node) can factor into the sparsity pattern determination (i.e., node aware optimization 526) and the bitmask generation (i.e., bitmask optimization 528). In further embodiments, such characteristics can be gleaned from the metadata of the node.

In specific embodiments of the invention, the system is configured to perform metadata exchange 530 in which the metadata of the node is collected. In some embodiments, the metadata of the node can be used in the bit-masking process 524 of block 520, where the system uses the characteristics of the node as gathered from the metadata of the node to determine the sparsity patten of the node and to determine a bitmask compression process. In further embodiments, the metadata can be used to perform missing data detection 540 to detect whether any data was lost or missing during the compression process. This can be done by comparing the metadata of the node before compression and the metadata of the node after compression. For example, if the size of the node is smaller after the data is decompressed than it was before the data was compressed, that may indicate some data is missing. In other specific embodiments, the metadata may be used for subsequent data analysis and/or data preparation 540.

In some embodiments of the invention, data encryption 560 is performed on the data during the bit-masking process 550. When the data is to be retrieved, a query 570 may be submitted to the distributed system for the data to be retrieved and decryption 580 of each node may be performed locally 570 during the retrieval process. In this way, encryption and decryption of the data provides for secure transmission 580 of the data to the end user. Query based and node-based encryption and decryption preserves privacy and data security because only data is not being decrypted en masse.

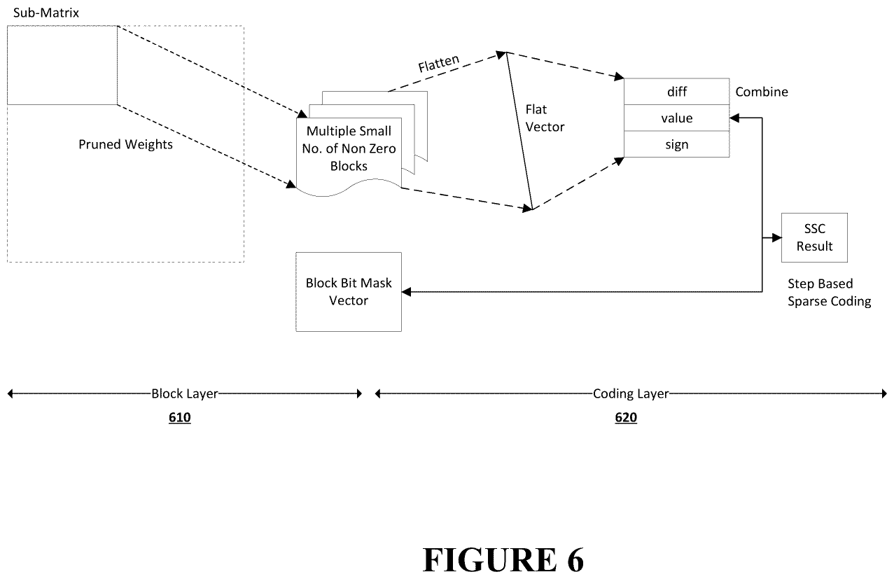

FIG. 6 depicts a method of handling sparse data during compression. FIG. 6 is divided into two parts: the block layer 610 and the coding layer 620. The block layer 610 depicts the data for compression being divided into subcategories. The data is split into non-zero blocks and zero blocks. In some embodiments of the invention, the zero blocks may be nodes of the dataset that are sparse, i.e., are empty contain zero or null values. The zero blocks are removed and the non-zero blocks are split into multiple smaller blocks. In some embodiments of the invention, a non-zero block may be a node that contains data. For example, a node that contains a column of a table where at least one cell of the column contains data may be a non-zero block and the column may be split into smaller blocks, where each cell is a block. Then, for each of the multiple smaller blocks, when there's a non-zero weight, the block is marked as true, i.e., 1. Otherwise, the block is marked as false, i.e., 0. Thus, the 0-marked blocks do not need to be considered during the compression process. Not having to consider the 0-marked, sparse blocks, may be helpful for handling high sparsity data and can accelerate the compression process and save storage too. All the 1-marked non-zero blocks may be compressed. The method then includes flattening all the non-zero blocks and the flattened vector is used as an input into the coding layer of the method. This process helps reduce the computing workload for data compression.

The coding layer 620 of the method for compression depicted in FIG. 6 includes high includes compressing the data by encoding using bits all the non-zero blocks from the block layer 610. In some embodiments of the invention, the method may include recording the relative position between each non-zero weight and the previous one and collecting and storing those values as well.

Thus, according to embodiments of the invention discussed in greater detail above, the present invention provides for the compression of data using bit-masking based on data sparsity patterns. Specifically, an AI engine receives a dataset with a number of nodes as input, analyzes each of the nodes for sparsity, determines a sparsity pattern for each node, determines a bitmask compression process for each node based on the sparsity pattern, and generates and allocates bits to compress the data in each node based on the bitmask compression process. In specific embodiments of the invention, sparsity patterns may include temporal sparsity, periodic sparsity, bursty sparsity, clustered sparsity, global sparsity, gradual sparsity, or an absence of sparsity. In some embodiments, the AI engine can analyze multiple, or all, nodes of a dataset, and generate and allocate bits to those nodes, based on each node's sparsity pattern, and determined bitmask compression process, simultaneously. In further embodiments of the invention, the AI engine may encrypt the data during the bitmask compression process and may compare metadata before and after compression to ensure no data is lost or missing. In yet other embodiments, the AI engine may adapt the bitmask compression process for nodes that do not align with known sparsity patterns and may use historical data to determine sparsity patterns and bitmask compression processes.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for compressing data based on sparsity types, the system comprising:
an artificial intelligence engine configured to:
receive as input a dataset, wherein the dataset comprises a plurality of nodes, and each node comprises data;
analyze each node for sparsity;
determine one of a plurality of sparsity patterns for each node;
determine, based on the determined sparsity pattern, a bitmask compression process for each node;
generate and allocate bits as part of the bitmask compression process to each node
in the dataset to compress the dataset, wherein a bit is a Boolean value of either one or zero.

2. The system of claim 1, wherein the plurality of sparsity patterns includes an absence of sparsity.

3. The system of claim 2, wherein the plurality of sparsity patterns also includes all of temporal sparsity, periodic sparsity, bursty sparsity, clustered sparsity, global sparsity, and gradual sparsity.

4. The system of claim 1, wherein the artificial intelligence engine is further configured to analyze, determine the sparsity pattern of, and generate and allocate bits for a plurality of the nodes of the dataset simultaneously.

5. The system of claim 1, wherein the artificial intelligence engine is further configured to encrypt the data in each node during the bitmask compression process.

6. The system of claim 1, wherein the artificial intelligence system is further configured to compare metadata associated with each node before and after compression to ensure no data was lost or missing during the bitmask compression process.

7. The system of claim 1, wherein the artificial intelligence engine is further configured to adapt the bitmask compression process for nodes that do not align with known sparsity patterns.

8. The system of claim 1, wherein the artificial intelligence system is further configured to use historical data to determine sparsity patterns and bitmask compression processes, wherein historical data comprises previous determinations of sparsity patterns and bitmask compression processes from previous dataset inputs.

9. A computer-implemented method for compressing data based on sparsity types, the method comprising:
receiving as input a dataset, wherein the dataset comprises a plurality of nodes, and each node comprises data;
analyzing each node for sparsity;
determining one of a plurality of sparsity patterns for each node;
determining, based on the determined sparsity pattern, a bitmask compression process for each node;
generating and allocating bits as part of the bitmask compression process to each node in the dataset to compress the dataset, wherein a bit is a Boolean value of either one or zero.

10. The method of claim 9, wherein the plurality of sparsity patterns includes an absence of sparsity.

11. The method of claim 10, wherein the plurality of sparsity patterns also includes the following known sparsity patterns: temporal sparsity, periodic sparsity, bursty sparsity, clustered sparsity, global sparsity, and gradual sparsity.

12. The method of claim 9, wherein the method further comprises analyzing, determining the sparsity pattern of, and generating and allocating bits for a plurality of the nodes of the dataset simultaneously.

13. The method of claim 9, wherein the method further comprises encrypting the data in each node during the bitmask compression process.

14. The method of claim 9, wherein the method further comprises comparing metadata associated with each node before and after compression to ensure no data was lost or missing during the bitmask compression process.

15. The method of claim 11, wherein the method further comprises adapting the bitmask compression process for nodes that do not align with the known sparsity patterns.

16. The method of claim 9, wherein the method further comprises using historical data to determine sparsity patterns and bitmask compression processes, wherein historical data comprises previous determinations of sparsity patterns and bitmask compression processes from previous dataset inputs.

17. A computer program product for compressing data based on sparsity types, the computer program product comprising at least one non-transitory computer-readable medium having computer-readable program code portions embodied therein, the computer-readable code portions comprising:
an executable portion configured to receive as input a dataset, wherein the dataset comprises a plurality of nodes, and each node comprises data;
an executable portion configured to analyze each node for sparsity;
an executable portion configured to determine one of a plurality of sparsity patterns of each node;
an executable portion configured to determine, based on the determined sparsity pattern, a bitmask compression process for each node;
an executable portion configured to generate and allocate bits as part of the bitmask compression process to each node in the dataset to compress the dataset, wherein a bit is a Boolean value of either one or zero.

18. The computer program product of claim 17, wherein the plurality of sparsity patterns includes an absence of sparsity.

19. The computer program product of claim 18, wherein the plurality of sparsity patterns also includes the following known sparsity patterns: temporal sparsity, periodic sparsity, bursty sparsity, clustered sparsity, global sparsity, and gradual sparsity.

20. The computer program product of claim 17, wherein the computer program product further includes an executable portion configured to analyze, determine the sparsity pattern of, and generate and allocate bits for a plurality of the nodes of a dataset simultaneously.
